(19) United States
(12) Patent Application Publication
(10) Pub. No.: US 2021/0250837 A1
(43) Pub. Date: Aug. 12, 2021

(54) CELL RESELECTION METHOD AND APPARATUS, AND STORAGE MEDIUM

(71) Applicant: BEIJING XIAOMI MOBILE SOFTWARE CO., LTD., Beijing (CN)

(72) Inventor: Wei HONG, Beijing (CN)

(73) Assignee: BEIJING XIAOMI MOBILE SOFTWARE CO., LTD., Beijing (CN)

(21) Appl. No.: 17/054,024

(22) PCT Filed: May 18, 2018
(86) PCT No.: PCT/CN2018/087540

§ 371 Date: Nov. 9, 2020

(51) Int. Cl. H04W 36/32; H04W 36/08; H04W 36/00; H04W 64/00

(52) U.S. Cl. CPC H04W 36/32; H04W 36/08; H04W 64/006; H04W 36/0061; H04W 36/0058

(57) ABSTRACT

Aspects of the disclosure provide a cell reselection method and apparatus, and a storage medium belonging to the technical field of wireless communications. The method can include, when cell reselection needs to be performed, a UE searching for a cell of a target type, the target type being determined on the basis of a motion speed state of the UE, and, when no cell of the target type is found within a first target duration, the UE reselecting and accessing a first target cell in neighbor cells, the neighbor cells of the UE not including the cell of the target type. The method can improve the probability that the UE reselects and accesses a suitable cell.

### RELATED APPLICATION

This application claims the benefit of International Application No. PCT/CN2018/087540, entitled “CELL RESELECTION METHOD AND APPARATUS, AND STORAGE MEDIUM” and filed on May 18, 2018, which is incorporated herein by reference in its entirety.

### TECHNICAL FIELD

The present disclosure generally relates to the technical field of wireless communications, including to a cell reselection method and device, and a storage medium.

### BACKGROUND

Cell reselection represent a process that user equipment (UE) in an idle state selects an optimal cell for providing communication service for it. Under a normal condition, in a cell reselection process, UE needs to measure neighbor cells thereof and determine the cell that the UE needs to reselect in the neighbor cells of the UE according to a measurement result. However, in such a cell reselection method, the probability that the UE reselects a suitable cell is relatively low.

### SUMMARY

The present disclosure provides a cell reselection method and device, and a storage medium, which may improve the probability that UE reselects a suitable cell.

According to a first aspect of the present disclosure, a cell reselection method is provided. The method can include that, when UE needs to perform cell reselection, a cell of a target type is searched for, the target type being determined based on a motion speed state of the UE, and, in response to no cell of the target type being found within a first target duration, a first target cell in neighbor cells of the UE is reselected, the neighbor cells of the UE including no cell of the target type.

Optionally, when the motion speed state of the UE is a high mobility state, the target type may be a cell type of a high-speed-railway dedicated network. Further, when the motion speed state of the UE is a non-high mobility state, the target type may be a cell type of a non-high-speed-railway dedicated network.

The method may further include, before searching for the cell of the target type, the motion speed state of the UE is determined according to a number of cell reselection times of the UE within a second target duration. Further, the method can include, before searching for the cell of the target type, the motion speed state of the UE is determined according to a number of cell handover times of the UE within a third target duration.

Optionally, the method may further include, before searching for the cell of the target type, the motion speed state of the UE is determined according to a movement distance of the UE within a fourth target duration. Additionally, in response to the cell of the target type being found within the first target duration, the cell of the target type is reselected.

The operation that the cell of the target type is reselected in response to the cell of the target type being found within the first target duration may include that, in response to at least two cells of the target type being found within the first target duration, a second target cell in the at least two cells of the target type is reselected, and the second target cell is determined according to a measurement result of the at least two cells of the target type.

Optionally, the first target cell may be determined according to a measurement result of the neighbor cells of the UE.

The method may further include that high-layer signaling sent by a base station is received, and the first target duration is determined according to an indication of the high-layer signaling. The first target duration can be determined according to the motion speed state of the UE. Optionally, the first target duration can be determined from a duration set, and the duration set includes at least one duration for searching for the cell of the target type that is specified in a communication protocol.

According to a second aspect of the present disclosure, a cell reselection device is provided. The device can include a searching module that is configured to, when UE needs to perform cell reselection, search for a cell of a target type, the target type being determined based on a motion speed state of the UE, and a first reselection module, that is configured to, in response to no cell of the target type being found within a first target duration, reselect a first target cell in neighbor cells of the UE, the neighbor cells of the UE including no cell of the target type.

Optionally, when the motion speed state of the UE is a high mobility state, the target type may be a cell type of a high-speed-railway dedicated network. Further, when the motion speed state of the UE is a non-high mobility state, the target type may be a cell type of a non-high-speed-railway dedicated network.

The device may further include a first motion speed state determination module, and the first motion speed state determination module may be configured to, before searching for the cell of the target type, determine the motion speed state of the UE according to a number of cell reselection times of the UE within a second target duration. Optionally, the device may further include a second motion speed state determination module, and the second motion speed state determination module may be configured to, before searching for the cell of the target type, determine the motion speed state of the UE according to a number of cell handover times of the UE within a third target duration. Additionally, the device may further include a third motion speed state determination module, and the third motion speed state determination module may be configured to, before searching for the cell of the target type, determine the motion speed state of the UE according to a movement distance of the UE within a fourth target duration.

Optionally, the device may further include a second reselection module, and the second reselection module may be configured to, in response to the cell of the target type being found within the first target duration, reselect the cell of the target type. The second reselection module may also include a reselection submodule, and the reselection submodule may be configured to, in response to at least two cells of the target type being found within the first target duration, reselect a second target cell in the at least two cells of the target type. The second target cell may be determined according to a measurement result of the at least two cells of the target type.

Optionally, the first target cell may be determined according to a measurement result of the neighbor cells of the UE.

The device may further include a receiving module and a first duration determination module. The receiving module may be configured to receive high-layer signaling sent by a base station. The first duration determination module may be configured to determine the first target duration according to an indication of the high-layer signaling.

Additionally, the device may further include a second duration determination module, and the second duration determination module may be configured to determine the first target duration according to the motion speed state of the UE. The device may further include a third duration determination module, and the third duration determination module may be configured to determine the first target duration from a duration set. The duration set includes at least one duration for searching for the cell of the target type that is specified in a communication protocol.

According to a third aspect of the present disclosure, UE is provided, which may include a processor, and a memory configured to store instructions executable by the processor. The processor may be configured to, when UE needs to perform cell reselection, search for a cell of a target type, the target type being determined based on a motion speed state of the UE. Further, in response to no cell of the target type being found within a first target duration, reselect a first target cell in neighbor cells of the UE, the neighbor cells of the UE including no cell of the target type.

According to a fourth aspect of the present disclosure, a non-transitory computer-readable storage medium is provided, in which a computer program may be stored, wherein the stored computer program may be executed by a processing component to implement any cell reselection method in the first aspect.

The technical solutions provided in the embodiments of the present disclosure provides beneficial effects. For example, when cell reselection needs to be performed, the UE searches for the cell of the target type, and reselects the first target cell in the neighbor cells of the UE when no cell of the target type is found within the first target duration. The target type is determined based on the motion speed state of the UE, and the neighbor cells of the UE include no cell of the target type. In such a manner, the UE may perform cell reselection in combination with its own motion speed state. Since the motion speed state of the UE is closely related to a cell type relatively suitable for the UE during reselection in some cases, if the UE performs cell reselection in combination with its own motion speed state, the probability that the UE reselects a suitable cell may be improved.

It is to be understood that the above general descriptions and detailed descriptions below are only exemplary and explanatory and not intended to limit the present disclosure.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1 is a schematic diagram illustrating an implementation environment, according to an exemplary embodiment.

FIG. 2 is a flow chart showing a cell reselection method, according to an exemplary embodiment.

FIG. 3 is a flow chart showing a cell reselection method, according to an exemplary embodiment.

FIG. 4 is a block diagram of a cell reselection device, according to an exemplary embodiment.

FIG. 5 is a block diagram of a cell reselection device, according to an exemplary embodiment.

FIG. 6 is a block diagram of a cell reselection device, according to an exemplary embodiment.

### DETAILED DESCRIPTION

Technical solutions and advantages of the present disclosure will be clear in view of the description of the exemplary embodiments of the present disclosure when taken in view of the accompanying drawings.

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of apparatuses and methods consistent with aspects related to the present disclosure as recited in the appended claims.

Along with the rapid development of high-speed railway technologies, more and more users select high-speed railways for travel, and how to ensure communication quality of a user on a train of the high-speed railway has become a popular research area in the technical field of wireless communication at present.

Since UE on the train is in a high mobility state, the UE on the train is likely to move from a signal coverage of a cell to a signal coverage of another cell in short time, such that the UE on the train needs to frequently perform cell reselection and cell handover. Frequent cell reselection and cell handover of the UE may not only increase the power consumption of the UE but also bring negative influence to the communication quality of the UE.

For avoiding frequent cell reselection and cell handover of UE on the train, a high-speed-railway dedicated network may usually be deployed along the high-speed railway. In the high-speed-railway dedicated network, baseband units and radio frequency units of base stations may be separated, and geographical positions of the radio frequency units may be remote. Optionally, multiple radio remote units (RRUs) in the high-speed-railway dedicated network may be deployed at different positions along the high-speed railway, and service is provided for cells of the same high-speed-railway dedicated network by use of the multiple RRUs. The geographical positions of the radio frequency units of the base stations in the high-speed-railway dedicated network may be remote, such that signal coverages of the cells in the high-speed-railway dedicated network are relatively wide, and frequent cell reselection and cell handover of the UE on the train may be avoided.

Since the signal coverages of the cells in the high-speed-railway dedicated network are relatively wide, UE which is not on the train may also reside in the cells of the high-speed-railway dedicated network, thereby bringing congestion of the high-speed-railway dedicated network and influencing the communication quality of the UE on the train. For avoiding congestion of the high-speed-railway dedicated network and ensuring the communication quality of the UE on the train, it is necessary to ensure that the UE reselects a suitable cell in a cell reselection process as much as possible. For the UE on the train, the suitable cell may be a cell of the high-speed-railway dedicated network. For the UE which is not on the train, the suitable cell may be a cell of a non-high-speed-railway dedicated network.

In the related art, during the cell reselection, UE may measure neighbor cells thereof and determine the cell that the UE needs to reselect in the neighbor cells of the UE according to a measurement result. However, the probability that the UE reselects a suitable cell is relatively low by using such a cell reselection method.

Exemplary embodiments of the present disclosure provide a cell reselection method. Through the cell reselection method, the probability that UE reselects a suitable cell may be improved. In the cell reselection method, when cell reselection needs to be performed, UE may search for a cell of a target type, and the target type is determined based on a motion speed state of the UE. When the UE finds no cell of the target type within a first target duration, the UE may reselect a first target cell in neighbor cells, and the neighbor cells of the UE include no cell of the target type. In such a manner, the UE may perform cell reselection in combination with its own motion speed state. Since the motion speed state of the UE may reflect whether the UE is on a train of a high-speed railway, the motion speed state of the UE is closely related to a cell type relatively suitable for the UE during reselection. Therefore, in the cell reselection method provided in embodiments of the present disclosure, if the UE performs cell reselection in combination with its own motion speed state, the probability that the UE reselects a suitable cell may be improved.

An implementation environment involved in the cell reselection method provided in the embodiments of the present disclosure will be briefly described below.

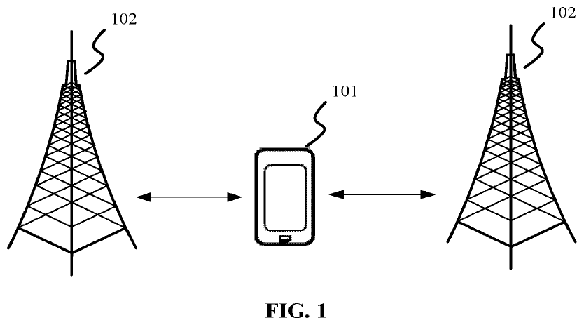

FIG. 1 is a schematic diagram illustrating an implementation environment involved in a cell reselection method, according to an exemplary embodiment of the present disclosure. As illustrated in FIG. 1, UE 101 and at least one base station 102 (only two base stations 102 are illustrated in FIG. 1) may be provided in the implementation environment. During cell reselection, the UE 101 may find cells served by each base station 102 in the at least one base station 102. The at least one base station 102 may include at least one of a base station in a high-speed-railway dedicated network or a base station in a non-high-speed-railway dedicated network.

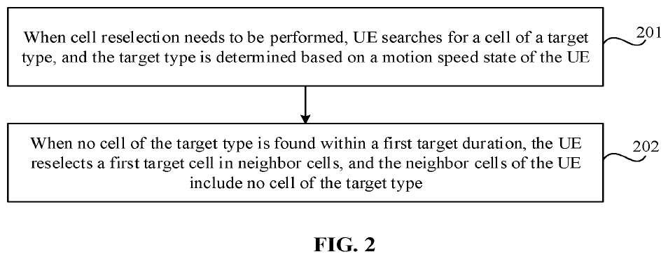

FIG. 2 is a flow chart showing a cell reselection method, according to an exemplary embodiment. As illustrated in FIG. 2, the cell reselection method is applied to the UE 101 illustrated in FIG. 1. The cell reselection method may include the following steps.

In step 201, when cell reselection needs to be performed, the UE searches for a cell of a target type, and the target type is determined based on a motion speed state of the UE.

In step 202, when no cell of the target type is found within a first target duration, the UE reselects a first target cell in neighbor cells, and the neighbor cells of the UE include no cell of the target type.

From the above, according to the cell reselection method provided in the embodiment of the present disclosure, when the cell reselection needs to be performed, the UE searches for the cell of the target type, and reselects the first target cell in the neighbor cells of the UE when no cell of the target type is found within the first target duration. The target type is determined based on the motion speed state of the UE, and the neighbor cells of the UE include no cell of the target type. In such a manner, the UE may perform cell reselection in combination with its own motion speed state. Since the motion speed state of the UE is closely related to a cell type relatively suitable for the UE during reselection in some cases, the UE performs cell reselection in combination with its own motion speed state, the probability that the UE reselects a suitable cell may be improved.

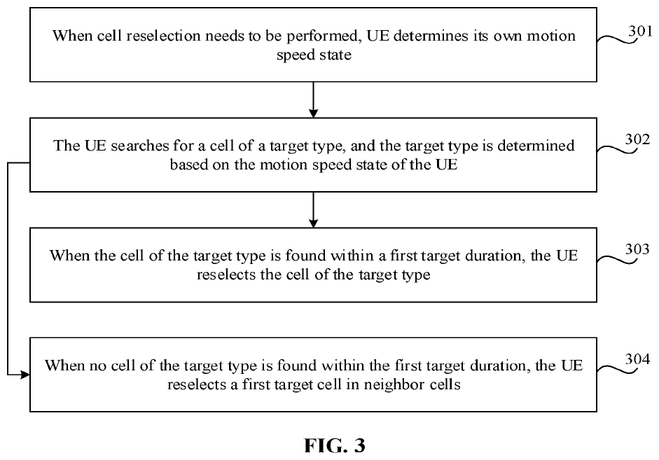

FIG. 3 is a flow chart showing a cell reselection method, according to an exemplary embodiment. As illustrated in FIG. 3, the cell reselection method is applied to the UE 101 illustrated in FIG. 1. The cell reselection method may include the following steps.

In step 301, when cell reselection needs to be performed, the UE determines its own motion speed state. When the cell reselection needs to be performed, the UE may determine its own motion speed state. In the embodiments of the present disclosure, the motion speed state of the UE may include a high mobility state and a non-high mobility state. Definitions of the high mobility state and the non-high mobility state are disclosed in a communication standard of the 3rd generation partnership project (3GPP) and will not be repeated in the embodiments of the present disclosure. It is to be pointed out that, when the UE is on a train, the UE is usually in the high mobility state; and when the UE is not on the train, the UE is usually in the non-high mobility state.

Three exemplary manners that the UE determines its own motion speed state are provided in the embodiments of the present disclosure.

In a first manner, the UE determines its own motion speed state according to a number of cell reselection times thereof.

Optionally, the UE may record a cell reselection moment every time after the cell reselection is performed. In a process that the UE determines its own motion speed state, the UE may acquire a number of cell reselection times of the UE within a second target duration prior to a present moment, and the present moment is a moment when the UE executes the technical process of determining its own motion speed state. The UE may represent a cell reselection frequency of the UE according to the acquired number of cell reselection times and further determine the motion speed state of the UE according to the acquired number of cell reselection times. Optionally, the UE may locally store a corresponding relationship table between a number of cell reselection times and a motion speed state of the UE, and the UE may query the corresponding relationship table according to the acquired number of cell reselection times, thereby obtaining the motion speed state of the UE.

Under a normal condition, when the UE is in the high mobility state, the number of cell reselection times of the UE within the second target duration is relatively large; and when the UE is in the non-high mobility state, the number of cell reselection times of the UE within the second target duration is relatively small.

In a second manner, the UE determines its own motion speed state according to a number of cell handover times thereof. Cell handover refers to that the UE completes transfer of a wireless link connection from a source cell to a target cell. Cell handover is basic technical means for ensuring seamless mobile communication service and may switch a communication in progress between different wireless cell channels without interruption.

Optionally, the UE may record a cell handover moment every time after the cell handover is performed. In the process that the UE determines its own motion speed state, the UE may acquire a number of cell handover times of the UE within a third target duration prior to the present moment, and the present moment is the moment when the UE executes the technical process of determining its own motion speed state. The UE may represent a cell handover frequency of the UE according to the acquired number of cell handover times and further determine the motion speed state of the UE according to the acquired number of cell handover times. Optionally, the UE may locally store a corresponding relationship table between a number of cell handover times and a motion speed state of the UE, and the UE may query the corresponding relationship table according to the acquired number of cell handover times, thereby obtaining the motion speed state of the UE.

Under a normal condition, when the UE is in the high mobility state, the number of cell handover times of the UE within the third target duration is relatively large; and when the UE is in the non-high mobility state, the number of cell handover times of the UE within the third target duration is relatively small.

In a third manner, the UE determines its own motion speed state according to a movement distance thereof within a fourth target duration. Optionally, the UE may acquire its own geographical position at an interval of the fourth target duration. For example, the UE may start its own global positioning system (GPS) component at an interval of the fourth target duration and acquire its own geographical position by use of the GPS component.

In the process that the UE determines its own motion speed state, the UE may acquire two adjacent geographical positions acquired by the UE prior to the present moment and determine the movement distance of the UE within the fourth target duration according to the two adjacent geographical positions that are acquired, and then the UE may determine its own motion speed state according to the movement distance thereof within the fourth target duration. The present moment is the moment when the UE executes the technical process of determining its own motion speed state. Optionally, the UE may locally store a corresponding relationship table between a movement distance and a motion speed state of the UE, and the UE may query the corresponding relationship table according to the determined movement distance thereof within the fourth target duration, thereby obtaining the motion speed state of the UE.

Under a normal condition, when the UE is in the high mobility state, the movement distance of the UE within the fourth target duration is relatively long; and when the UE is in the non-high mobility state, the movement distance of the UE within the fourth target duration is relatively short.

It is to be pointed out that the second target duration, the third target duration and the fourth target duration may be configured by a base station through high-layer signaling, may also be specified in a communication protocol and may also be autonomously determined by the UE, which are not limited in the embodiments of the present disclosure.

In step 302, the UE searches for a cell of a target type, and the target type is determined based on the motion speed state of the UE. The UE, after determining its own motion speed state, may determine a type (i.e., the abovementioned target type) of a cell to be searched for according to its own motion speed state, and the cell to be searched for is a suitable cell that the UE needs to reselect as much as possible.

Optionally, when the motion speed state of the UE is the high mobility state, it is indicated that the UE is likely to be on the train, and in such case, the target type may be a cell type of a high-speed-railway dedicated network. When the motion speed state of the UE is the non-high mobility state, it is indicated that the UE is likely to be not on the train, and in such case, the target type may be a cell type of a non-high-speed-railway dedicated network.

It is to be pointed out that a first speed threshold value and a second speed threshold value may be the same and may also be different. The first speed threshold value and the second speed threshold value may be configured by the base station through the high-layer signaling, may also be specified in the communication protocol and may also be autonomously determined by the UE, which are not limited in the embodiments of the present disclosure.

After the UE determines the target type according to its own motion speed state, the UE may search for the cell of the target type.

Optionally, the base station may broadcast type information of a cell served by the base station, and the type information is configured to indicate whether the cell served by the base station is a cell of the high-speed-railway dedicated network. The UE may receive such type information broadcast by at least one base station and search the received type information to determine whether target type information exists, and the target type information is configured to indicate that the cell served by the base station is a cell of the high-speed-railway dedicated network. If the UE finds the target type information in the received type information, it means that the UE finds the cell of the target type, and the cell of the target type is a cell indicated by the target type information. If the UE does not find the target type information in the received type information, it means that the UE finds no cell of the target type.

In step 303, when the cell of the target type is found within a first target duration, the UE reselects the cell of the target type. When the UE finds the cell of the target type within the first target duration, it is indicated that there is the cell of the target type around the UE, and in such case, the UE may reselect the cell of the target type, thereby ensuring that the UE may reselect a suitable cell in the cell reselection process. It can be seen from the above descriptions that, when the UE is on the train, the suitable cell (i.e., the cell of the target type) is a cell of the high-speed-railway dedicated network; and when the UE is not on the train, the suitable cell (i.e., the cell of the target type) is a cell of the non-high-speed-railway dedicated network.

During practical implementation, there is likely a condition that the UE finds at least two cells of the target type within the first target duration, that is, the condition that there are at least two cells of the target type around the UE is very likely to occur. When this condition occurs, for ensuring that the UE may reselect an optimal cell, the UE may measure the at least two cells of the target type and determine a second target cell according to a measurement result, and in the cell reselection process, the UE may reselect the second target cell.

Optionally, measurement executed by the UE on the at least two cells of the target type may be intra-frequency measurement and may also be inter-frequency measurement. When measurement executed by the UE on the at least two cells of the target type is intra-frequency measurement, the UE may obtain reference signal receiving power (RSRP) of each cell of the target type in the at least two cells of the target type, and may determine the second target cell according to the RSRP of the at least two cells of the target type. When measurement executed by the UE on the at least two cells of the target type is inter-frequency measurement, the UE may acquire frequency point information of the at least two cells of the target type, and may determine the cell, of which a priority of the frequency point information is highest, of the target type as the second target type.

In addition, during practical implementation, there also likely a condition that the UE may not find any cell of the target type. Under this condition, since the UE may not find any cell of the target type, the UE cannot complete the cell reselection, thereby resulting in the condition that there is no cell where the UE may reside. For avoiding the condition that there is no cell where the UE may reside, a duration (i.e., the first target duration) when the UE searches for the cell of the target type may be limited in the embodiments of the present disclosure to ensure that the UE searches for the cell of the target type only within the first target duration. When the UE finds the cell of the target type within the first target duration, the UE may reselect the cell of the target type. When the UE finds no cell of the target type within the first target duration, the UE may reselect a cell of a non-target type. It can be seen from the above descriptions that, when the UE is on the train, the cell of the non-target type is a cell of the non-high-speed-railway dedicated network; and when the UE is not on the train, the cell of the non-target type is a cell of the high-speed-railway dedicated network. Therefore, on one hand, it may be ensured that the UE may reselect a suitable cell (i.e., the cell of the target type) as much as possible, and on the other hand, the condition that there is no cell where the UE may reside may be avoided.

In a possible implementation mode, the base station may send the high-layer signaling to the UE, and the high-layer signaling is configured to indicate the first target duration. After receiving the high-layer signaling, the UE may determine the first target duration according to an indication of the high-layer signaling.

In another possible implementation mode, the UE may determine the first target duration according to its own motion speed state. For example, the UE may locally store a corresponding relationship table between a motion speed state and a first target duration, and the UE may query the corresponding relationship table according to the motion speed state determined in step 301, thereby determining the first target duration. Under a normal condition, when the motion speed state of the UE is the high mobility state, the first target duration is relatively small. This is because the number of cells that the UE passes in the same time is larger if the mobility of the UE is higher, and furthermore, the UE may determine whether there is the cell of the target type around the UE by searching for relatively short time.

In another possible implementation mode, the UE may determine the first target duration from a duration set, and the duration set includes at least one duration for searching for the cell of the target type that is specified in a communication protocol.

In step 304, when no cell of the target type is found within the first target duration, the UE reselects a first target cell in neighbor cells.

As mentioned above, for avoiding the condition that there is no cell where the UE may reside, when no cell of the target type is found within the first target duration, the UE may reselect the first target cell in the neighbor cells, the neighbor cells of the UE include no cell of the target type, and the first target cell is determined by the UE according to a measurement result of the neighbor cells.

It is to be pointed out that measurement executed by the UE on the neighbor cells may be intra-frequency measurement or inter-frequency measurement. When measurement executed by the UE on the neighbor cells is intra-frequency measurement, the UE may obtain RSRP of each neighbor cell and determine the first target cell according to the RSRP of the neighbor cells. When measurement executed by the UE on the neighbor cells is inter-frequency measurement, the UE may acquire frequency point information of each neighbor cell and determine the cell of which a priority of the frequency point information is highest as the first target cell.

From the above, according to the cell reselection method provided in the embodiments of the present disclosure, when the cell reselection needs to be performed, the UE searches for the cell of the target type, and reselects the first target cell in the neighbor cells of the UE when no cell of the target type is found within the first target duration. The target type is determined based on the motion speed state of the UE, and the neighbor cells of the UE include no cell of the target type. In such a manner, the UE may perform the cell reselection in combination with its own motion speed state. Since the motion speed state of the UE is closely related to a cell type relatively suitable for the UE during reselection in some cases, if the UE performs the cell reselection in combination with its own motion speed state, the probability that the UE reselects a suitable cell may be improved.

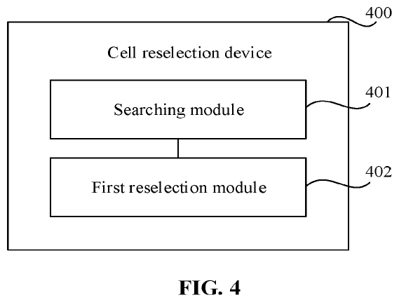

FIG. 4 is a block diagram of a cell reselection device 400, according to an exemplary embodiment. The cell reselection device 400 may be arranged in the UE 101 illustrated in FIG. 1. Referring to FIG. 4, the cell reselection device 400 includes a searching module 401 and a first reselection module 402. Of course, it should be understood that any of the modules described in this specification can be implemented by circuitry.

The searching module 401 is configured to, when the UE needs to perform cell reselection, search for a cell of a target type. The target type is determined based on a motion speed state of the UE.

The first reselection module 402 is configured to, when no cell of the target type is found within a first target duration, reselect a first target cell in neighbor cells of the UE. The neighbor cells of the UE include no cell of the target type.

In an embodiment of the present disclosure, when the motion speed state of the UE is a high mobility state, the target type is a cell type of a high-speed-railway dedicated network. Further, when the motion speed state of the UE is a non-high mobility state, the target type is a cell type of a non-high-speed-railway dedicated network. In an embodiment of the present disclosure, the first target cell is determined according to a measurement result of the neighbor cells of the UE.

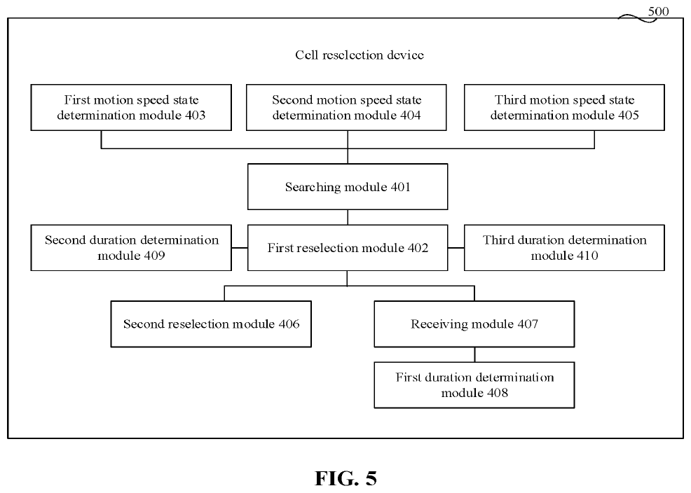

As illustrated in FIG. 5, the embodiments of the present disclosure also provide another cell reselection device 500. Besides the modules of the cell reselection device 400, the cell reselection device 500 can further include at least one of a first motion speed state determination module 403, a second motion speed state determination module 404, a third motion speed state determination module 405, a second reselection module 406, a receiving module 407, a first duration determination module 408, a second duration determination module 409, or a third duration determination module 410. FIG. 5 is drawn only with the condition that the cell reselection device 500 includes all modules of the first motion speed state determination module 403, the second motion speed state determination module 404, the third motion speed state determination module 405, the second reselection module 406, the receiving module 407, the first duration determination module 408, the second duration determination module 409 and the third duration determination module 410 as an example.

The first motion speed state determination module 403 is configured to, before searching for the cell of the target type, determine the motion speed state of the UE according to a number of cell reselection times of the UE within a second target duration.

The second motion speed state determination module 404 is configured to, before searching for the cell of the target type, determine the motion speed state of the UE according to a number of cell handover times of the UE within a third target duration.

The third motion speed state determination module 405 is configured to, before searching for the cell of the target type, determine the motion speed state of the UE according to a movement distance of the UE within a fourth target duration.

The second reselection module 406 is configured to, when the cell of the target type is found within the first target duration, reselect the cell of the target type.

In an embodiment of the present disclosure, the second reselection module can include a reselection submodule. The reselection submodule is configured to, when at least two cells of the target type are found within the first target duration, reselect a second target cell in the at least two cells of the target type, and the second target cell is determined according to a measurement result of the at least two cells of the target type.

The receiving module 407 is configured to receive high-layer signaling sent by a base station.

The first duration determination module 408 is configured to determine the first target duration according to an indication of the high-layer signaling.

The second duration determination module 409 is configured to determine the first target duration according to the motion speed state of the UE.

The third duration determination module 410 is configured to determine the first target duration from a duration set, and the duration set includes at least one duration for searching for the cell of the target type that is specified in a communication protocol.

From the above, according to the cell reselection device provided in the embodiments of the present disclosure, when the cell reselection needs to be performed, the cell of the target type is searched for, and when no cell of the target type is found within the first target duration, the first target cell in the neighbor cells of the UE is reselected. The target type is determined based on the motion speed state of the UE, and the neighbor cells of the UE include no cell of the target type. In such a manner. The UE may perform the cell reselection in combination with its own motion speed state. Since the motion speed state of the UE is closely related to a cell type relatively suitable for the UE during reselection in some cases, if the UE performs cell reselection in combination with its own motion speed state, the probability that the UE reselects a suitable cell may be improved.

With respect to the device in the above embodiments, the specific manners for performing operations for individual modules therein have been described in detail in the embodiments regarding the method, which will not be repeated herein.

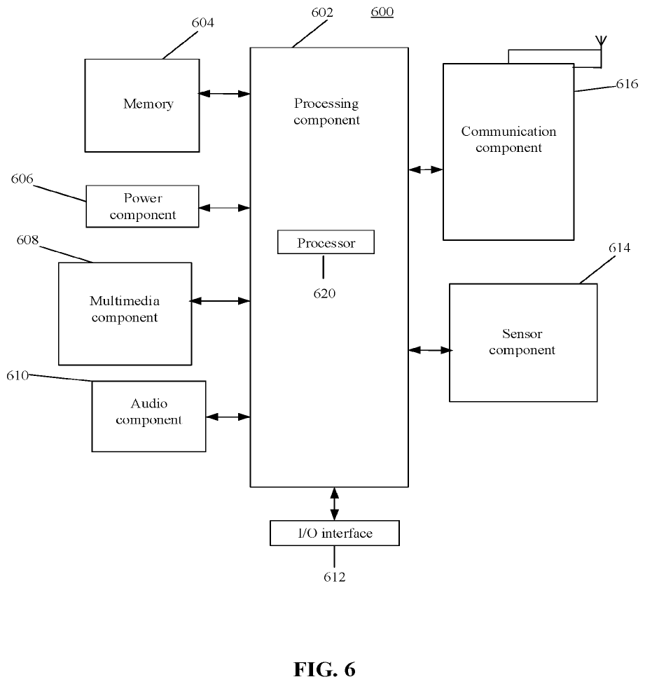

FIG. 6 is a block diagram of a cell reselection device 600, according to an exemplary embodiment. For example, the device 600 may be a mobile phone, a computer, a digital broadcast terminal, a messaging device, a gaming console, a tablet, a medical device, exercise equipment, a personal digital assistant, and the like.

Referring to FIG. 6, the device 600 may include one or more of the following components: a processing component 602, a memory 604, a power component 606, a multimedia component 608, an audio component 610, an input/output (I/O) interface 612, a sensor component 614, and a communication component 616.

The processing component 602 typically controls overall operations of the device 600, such as the operations associated with display, telephone calls, data communications, camera operations, and recording operations. The processing component 602 may include one or more processors 620 to execute instructions to perform all or part of the steps in the abovementioned method. Moreover, the processing component 602 may include one or more modules which facilitate interaction between the processing component 602 and other components. For instance, the processing component 602 may include a multimedia module to facilitate interaction between the multimedia component 608 and the processing component 602.

The memory 604 is configured to store various types of data to support the operation of the device 600. Examples of such data include instructions for any applications or methods operated on the device 600, contact data, phonebook data, messages, pictures, video, etc. The memory 604 may be implemented by any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, and a magnetic or optical disk.

The power component 606 provides power for various components of the device 600. The power component 606 may include a power management system, one or more power supplies, and other components associated with generation, management and distribution of power for the device 600.

The multimedia component 608 includes a screen providing an output interface between the device 600 and a user. In some embodiments, the screen may include a liquid crystal display (LCD) and a touch panel (TP). If the screen includes the TP, the screen may be implemented as a touch screen to receive an input signal from the user. The TP includes one or more touch sensors to sense touches, swipes and gestures on the TP. The touch sensors may not only sense a boundary of a touch or swipe action, but also detect a period of time and a pressure associated with the touch or swipe action. In some embodiments, the multimedia component 608 includes a front camera and/or a rear camera. The front camera and/or the rear camera may receive external multimedia data when the device 600 is in an operation mode, such as a photographing mode or a video mode. Each of the front camera and the rear camera may be a fixed optical lens system or have focusing and optical zooming capabilities.

The audio component 610 is configured to output and/or input an audio signal. For example, the audio component 610 includes a microphone (MIC), and the MIC is configured to receive an external audio signal when the device 600 is in an operation mode, such as a call mode, a recording mode and a voice recognition mode. The received audio signal may further be stored in the memory 604 or sent through the communication component 616. In some embodiments, the audio component 610 further includes a speaker configured to output the audio signal.

The I/O interface 612 provides an interface between the processing component 602 and peripheral interface modules, such as a keyboard, a click wheel, buttons, and the like. The buttons may include, but are not limited to a home button, a volume button, a starting button, and a locking button.

The sensor component 614 includes one or more sensors configured to provide status assessments in various aspects for the device 600. For instance, the sensor component 614 may detect an on/off status of the device 600 and relative positioning of components, such as a display and small keyboard of the device 600, and the sensor component 614 may further detect a change in a position of the device 600 or a component of the device 600, presence or absence of contact between the user and the device 600, orientation or acceleration/deceleration of the device 600 and a change in temperature of the device 600. The sensor component 614 may include a proximity sensor configured to detect presence of an object nearby without any physical contact. The sensor component 614 may also include a light sensor, such as a complementary metal oxide semiconductor (CMOS) or charge coupled device (CCD) image sensor, configured for use in an imaging application. In some embodiments, the sensor component 614 may also include an acceleration sensor, a gyroscope sensor, a magnetic sensor, a pressure sensor or a temperature sensor.

The communication component 616 is configured to facilitate wired or wireless communication between the device 600 and other devices. The device 600 may access any communication-standard-based wireless network, such as a Wi-Fi network, a 2nd-generation (2G) or 3rd-generation (3G) network or a combination thereof. In an exemplary embodiment, the communication component 616 receives a broadcast signal or broadcast associated information from an external broadcast management system through a broadcast channel. In an exemplary embodiment, the communication component 616 further includes a near field communication (NFC) module to facilitate short-range communications. For example, the NFC module may be implemented based on a radio frequency identification (RFID) technology, an infrared data association (IrDA) technology, an ultra-wide band (UWB) technology, a Bluetooth (BT) technology, and other technologies.

In an exemplary embodiment, the device 600 may be implemented by one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors or other electronic components, and is configured to execute the abovementioned method.

In an exemplary embodiment, there is also provided a non-transitory computer-readable storage medium including instructions, such as included in the memory 604, executable by the processor 620 of the device 600 for performing the abovementioned methods. For example, the non-transitory computer-readable storage medium may be a ROM, a random access memory (RAM), a compact disc read-only memory (CD-ROM), a magnetic tape, a floppy disc, an optical data storage device, and the like.

In an exemplary embodiment, there is also provided a non-transitory computer-readable storage medium, instructions in the storage medium are executed by a processor of a mobile terminal to cause the mobile terminal to execute the steps in the cell reselection method provided in the embodiments of the present disclosure.

In an exemplary embodiment, there is also provided a computer-readable storage medium. The computer-readable storage medium is a non-volatile computer-readable storage medium. A computer program is stored in the computer-readable storage medium. The stored computer program is executed by a processing component to implement the cell reselection method provided in the abovementioned embodiments of the present disclosure.

The embodiments of the present disclosure also provide a computer program product, in which instructions are stored, the instructions are executed by a computer to cause the computer to execute the cell reselection method provided in the embodiments of the present disclosure.

The embodiments of the present disclosure also provide a chip, which includes a programmable logic circuit and/or program instructions and may be executed to peform the cell reselection method provided in the embodiments of the present disclosure.

Other implementation solutions of the present disclosure will be apparent to those skilled in the art from consideration of the specification and practice of the present disclosure. This application is intended to cover any variations, uses, or adaptations of the present disclosure following the general principles thereof and including such departures from the present disclosure as come within known or customary practice in the art. It is intended that the specification and examples be considered as exemplary only, with a true scope and spirit of the present disclosure being indicated by the following claims.

It will be appreciated that the present disclosure is not limited to the exact construction that has been described above and illustrated in the accompanying drawings, and that various modifications and changes may be made without departing from the scope thereof. It is intended that the scope of the present disclosure only be limited by the appended claims.

1. A cell reselection method, comprising:
searching for a cell of a target type when user equipment (UE) needs to perform cell reselection, the target type being determined based on a motion speed state of the UE; and
reselecting a first target cell in neighbor cells of the UE when no cell of the target type is found within a first target duration, the neighbor cells of the UE having no cell of the target type.

2. The method of claim 1, wherein, when the motion speed state of the UE is a high mobility state, the target type is a cell type of a high-speed-railway dedicated network.

3. The method of claim 1, wherein, when the motion speed state of the UE is a non-high mobility state, the target type is a cell type of a non-high-speed-railway dedicated network.

4. The method of claim 1, further comprising:
determining, before searching for the cell of the target type, the motion speed state of the UE according to a number of cell reselection times of the UE within a second target duration.

5. The method of claim 1, further comprising:
determining, before searching for the cell of the target type, the motion speed state of the UE according to a number of cell handover times of the UE within a third target duration.

6. The method of claim 1, further comprising:
determining, before searching for the cell of the target type, the motion speed state of the UE according to a movement distance of the UE within a fourth target duration.

7. The method of claim 1, further comprising:
reselecting, in response to the cell of the target type being found within the first target duration, the cell of the target type.

8. The method of claim 7, wherein reselecting the cell of the target type in response to the cell of the target type is found within the first target duration further comprises:
reselecting a second target cell in at least two cells of the target type when the at least two cells of the target type are found within the first target duration, wherein the second target cell is determined based on a measurement result of the at least two cells of the target type.

9. The method of claim 1, wherein the first target cell is determined according to a measurement result of the neighbor cells of the UE.

10. The method of claim 1, further comprising:
receiving high-layer signaling sent by a base station; and
determining the first target duration according to an indication of the high-layer signaling.

11. The method of claim 1, further comprising:
determining the first target duration according to the motion speed state of the UE.

12. The method of claim 1, further comprising:
determining the first target duration from a duration set, wherein the duration set comprises at least one duration for searching for the cell of the target type that is specified in a communication protocol.

13. (canceled)

14. User equipment (UE), comprising:
a processor; and
a memory configured to store instructions executable by the processor,
wherein the processor is configured to:
search, when the UE needs to perform cell reselection, for a cell of a target type, the target type being determined based on a motion speed state of the UE; and
reselect, in response to no cell of the target type being found within a first target duration, a first target cell in neighbor cells of the UE, the neighbor cells of the UE comprising no cell of the target type.

15. A non-transitory computer-readable storage medium storing a computer program that, when executed by a processing component, causes the processing component to implement a cell reselection method comprising:
searching for a cell of a target type when user equipment (UE) needs to perform cell reselection, the target type being determined based on a motion speed state of the UE; and
reselecting a first target cell in neighbor cells of the UE when no cell of the target type is found within a first target duration, the neighbor cells of the UE having no cell of the target type.

16. The UE of claim 14, wherein the processor is further configured to determine the motion speed state of the UE based on a number of cell reselection times of the UE within a second target duration before searching for the cell of the target type.

17. The UE of claim 14, wherein the processor is further configured to determine the motion speed state of the UE based on a number of cell handover times of the UE within a third target duration before searching for the cell of the target type.

18. The UE of claim 14, wherein the processor is further configured to determine the motion speed state of the UE based on a movement distance of the UE within a fourth target duration before searching for the cell of the target type.

19. The UE of claim 14, wherein the processor is further configured to receive high-layer signaling sent by a base station, and determine the first target duration based on an indication of the high-layer signaling.

20. The UE of claim 14, wherein the processor is further configured to determine the first target duration based on the motion speed state of the UE.

21. The UE of claim 14, wherein the processor is further configured to determine the first target duration from a duration set, wherein the duration set comprises at least one duration for searching for the cell of the target type that is specified in a communication protocol.
